(19) United States
(12) Patent Application Publication
(10) Pub. No.: US 2022/0144169 A1
(43) Pub. Date: May 12, 2022

(54) REAR-VIEW CAMERA SYSTEM FOR A TRAILER HITCH SYSTEM

(71) Applicant: Robert Bosch GmbH, Stuttgart (DE)

(72) Inventors: Christian Sperrle, Ann Arbor, MI (US); James Stephen Miller, Dexter, MI (US); Phanikumar K. Bhamidipati, Novi, MI (US)

(21) Appl. No.: 17/521,427

(22) Filed: Nov. 8, 2021

Related U.S. Application Data
(60) Provisional application No. 63/110,767, filed on Nov. 6, 2020.

(51) Int. Cl. B60R 1/00; B60R 11/04; G06K 9/00; G06T 19/00

(52) U.S. Cl. CPC B60R 1/00; B60R 11/04; G06K 9/00791; G06T 19/006; G06T 2207/30252; B60R 2300/802; B60R 2300/303; B60R 2300/8086; B60R 2300/105

(57) ABSTRACT

A method for generating a rear-view display of a vehicle coupled to a trailer. The method includes detecting that the vehicle is in a reverse gear or is turning and determining a trailer angle of the vehicle. The method further includes generating a blended image based on the trailer angle, a first video image from a rear-facing vehicle camera positioned on the vehicle, the first video image including a first region of interest including a trailer coupled to the vehicle, and a second video image from a rear-facing trailer camera positioned on the trailer, the second video image including a second region of interest of a rearview of the trailer, the blended image including an overlay of at least a portion of the second video image over the trailer in the first video image and displaying the blended image on the display.

### CROSS-REFERENCE TO RELATED APPLICATION

The present application claims priority to U.S. Provisional Patent Application No. 63/110,767, filed Nov. 6, 2020, the entire content of which is incorporated herein by reference.

### FIELD

Embodiments relate to automotive camera systems.

### BACKGROUND

Vehicles, such as automobiles, trucks, SUVs, vans, recreational vehicles, etc., may be equipped with a rear camera system, sometimes known as a backup camera or reversing camera. The rear camera is configured to capture an image of the area behind the vehicle, which is then transferred to a display, allowing a driver of the vehicle to view the area behind the vehicle. When the vehicle is coupled to a trailer, the trailer may introduce one or more blind spots and obstruct the view of objects behind the vehicle.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a trailer camera system, according to some embodiments.

FIG. 2 is a block diagram of an electronic controller of the trailer camera system of FIG. 1, according to some embodiments.

FIG. 3 is a flow chart of method for generating a rear-view display of a vehicle coupled to a trailer of the system of FIG. 1, according to some embodiments.

FIG. 4A is an example rear-view video image captured by a vehicle camera of the system of FIG. 1, according to some embodiments.

FIG. 4B is an example rear-view video image captured by a trailer camera of the system of FIG. 1, according to some embodiments.

FIG. 4C is an example of a blended image of the images of FIGS. 4A and 4B, according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### SUMMARY

The present specification relates generally to the field of rear camera systems for vehicles. Vehicles, such as automobiles, trucks, SUVs, vans, recreational vehicles, etc., may be equipped with a rear camera system, sometimes known as a backup camera or reversing camera. The rear camera is configured to capture an image of the area behind the vehicle, generally the area towards the ground. The area may include a blind spot hidden from view of the rear-view mirror and side view mirrors. The image is transferred to a display, allowing the driver to monitor the area behind the vehicle.

Embodiments presented herein include systems and methods for generating a rear-view trailer video image.

### DETAILED DESCRIPTION

Before any embodiments are explained in detail, it is to be understood that the examples presented herein are not limited in their application to the details of construction and the arrangement of components set forth in the following description or illustrated in the following drawings. Embodiments may be practiced or carried out in various ways.

It should also be noted that a plurality of hardware and software-based devices, as well as a plurality of different structural components may be used to implement the embodiments presented herein. In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects may be implemented in software (for example, stored on non-transitory computer-readable medium) executable by one or more processors. As such, it should be noted that a plurality of hardware and software-based devices, as well as a plurality of different structural components may be utilized to implement the embodiments presented. For example, “control units” and “controllers” described in the specification can include one or more electronic processors, one or more memory modules including non-transitory computer-readable medium, one or more input/output interfaces, and various connections (for example, a system bus) connecting the components.

For ease of description, each of the example systems presented herein is illustrated with a single exemplar of each of its component parts. Some examples may not describe or illustrate all components of the systems. Other embodiments may include more or fewer of each of the illustrated components, may combine some components, or may include additional or alternative components.

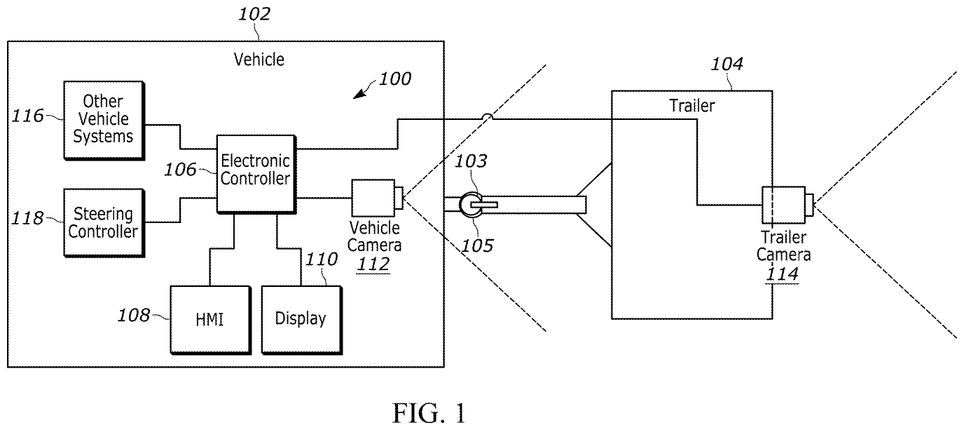

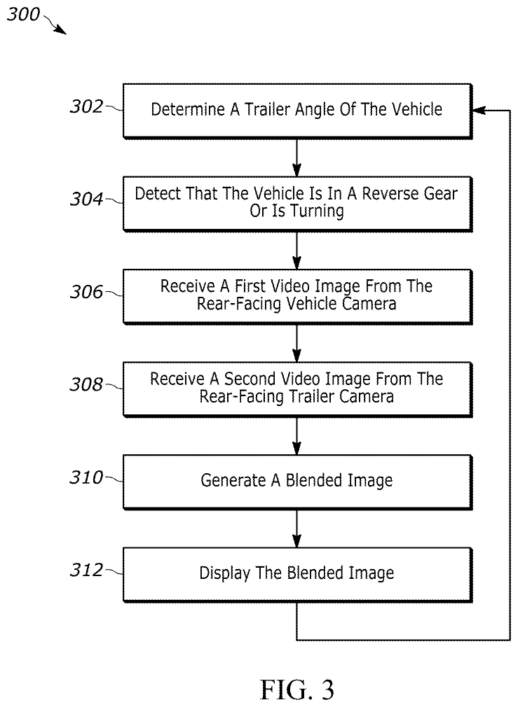

FIG. 1 is a block diagram of one example embodiment of a trailer camera system 100. The trailer camera system 100 is integrated into a vehicle 102 and a trailer 104. The vehicle 102 is equipped with a trailer hitch 103. positioned at the rear of the vehicle 102. The trailer 104 has a trailer coupling (or coupler) 105 positioned at the front of the trailer 104. The trailer hitch 103 may one of numerous kinds of hitches (for example, a ball type trailer hitch having a ball) or, for example, a hitch that is received by a recess of the trailer coupler 105 to connect (or hitch) the trailer 104 to the vehicle 102. The trailer 104 may one of numerous types of vehicle trailers (for example, an enclosed trailer, vehicle hauling trailer, recreational vehicle (RV) trailer, and the like). While the trailer 104 is described below (in particular, regarding the method 300 in FIG. 3) as being an enclosed trailer, this should not be considered limiting. The systems and methods described herein are applicable to other types of trailers.

The trailer camera system 100 includes an electronic controller 106, a human machine interface (HMI) 108, a display 110, a plurality of cameras including a vehicle camera 112 and a trailer camera 114, and other vehicle systems 116. The electronic controller 106, the HMI 108, the display 110, the plurality of cameras, and the other vehicle systems 116, as well as other various modules and components of the vehicle 102 are communicatively coupled to each other via wired connections, wireless connections, or some combination thereof. All or parts of the connections used in the system 100 may be implemented using various communication networks, for example, a Bluetooth™ network, a control area network (CAN), a wireless local area network (for example, Wi-Fi), a wireless accessory Personal Area Networks (PAN), and the like. The use of communication networks for the interconnection between and exchange of information among the various modules and components would be apparent to a person skilled in the art in view of the description provided herein.

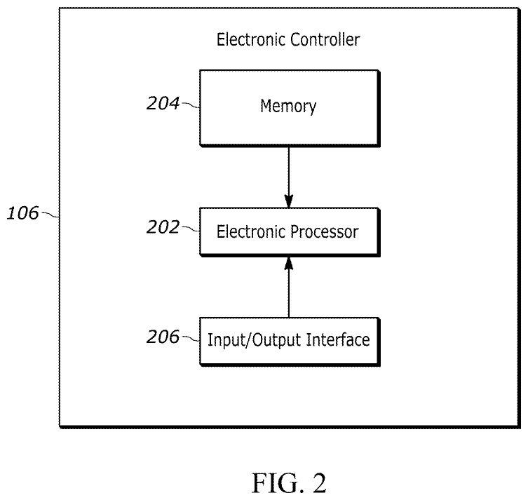

In some embodiments, the electronic controller 106 includes a plurality of electrical and electronic components that provide power, operational control, and protection to the components and modules within the electronic controller 106. As shown in FIG. 2, the electronic controller 106 includes, among other things, an electronic processor 202 (for example, an electronic microprocessor, microcontroller, or other suitable programmable device), a memory 206, and an input/output interface 208. The electronic processor 202, the memory 204, and the input/output interface 206, as well as the other various modules are connected by one or more control or data buses. In some embodiments, the electronic controller 106 is implemented partially or entirely in hardware (for example, using a field-programmable gate array (“FPGA”), an application specific integrated circuit (“ASIC”), or other devices.

The electronic processor 202 obtains and provides information (for example, from the memory 204 and/or the input/output interface 206), and processes the information by executing one or more software instructions or modules, capable of being stored, for example, in a random access memory (“RAM”) area of the memory 204 or a read only memory (“ROM”) of the memory 204 or another non-transitory computer readable medium (not shown). The software can include firmware, one or more applications, program data, filters, rules, one or more program modules, and other executable instructions.

The memory 204 can include one or more non-transitory computer-readable media and includes a program storage area and a data storage area. As used in the present application, “non-transitory computer-readable media” comprises all computer-readable media but does not consist of a transitory, propagating signal. The program storage area and the data storage area can include combinations of different types of memory, for example, read-only memory (“ROM”), random access memory (“RAM”), electrically erasable programmable read-only memory (“EEPROM”), flash memory, or other suitable digital memory devices. The electronic processor 202 is connected to the memory 204 and executes software, including firmware, one or more applications, program data, filters, rules, one or more program modules, and other executable instructions. The electronic processor 202 retrieves from the memory 204 and executes, among other things, instructions related to the control processes and methods described herein.

The input/output interface 206 is configured to receive input and to provide system output. The input/output interface 206 obtains information and signals from, and provides information and signals to (for example, over one or more wired and/or wireless connections) devices and/or components both internal and external to the system 100.

In some embodiments, the electronic controller 106 may include additional, fewer, or different components. For example, in some embodiments, the controller electronic 106 may include a transceiver or separate transmitting and receiving components, for example, a transmitter and a receiver. Some or all of the components of electronic controller 106 may be dispersed and/or integrated into other devices/components of the system 100 (for example, a vehicle control module or VCM, not shown, of the vehicle 102).

Returning to FIG. 1, each of the cameras of the system 100 are video cameras, positioned to capture video images of an area surrounding the vehicle 102. It should be understood that, while only the vehicle camera 112 and trailer camera 114 are illustrated, the system 100 may include multiple cameras, including multiple vehicle cameras and trailer cameras. In some embodiments one or more of the cameras are moveable (for example, using pan, tilt, or zoom functions) to capture video images of other areas on or around the vehicle 102. The vehicle camera 112 is a rear-facing video camera, positioned to capture video images of an area to the rear of the vehicle 102, such video images including at least a portion of the trailer 104. The vehicle camera 112 may be, for example, part of a back-up video camera system. Backup video cameras are known and will not be described in further detail. The trailer camera 114 is a rear-facing video camera, positioned to capture video images of an area to the rear of the trailer 104.

The HMI 108 provides an interface between the vehicle 102 and the driver. The HMI 108 is communicatively coupled to the electronic controller 106 and receives input from the driver, receives information from the electronic controller 106, and provides feedback (for example, audio, visual, haptic, or a combination thereof) to the driver based on the received information. The HMI 108 provides suitable input mechanisms, for example, a button, a touch-screen display having menu options, voice recognition, and the like for providing inputs from the driver that may be used by the electronic controller 106 as it controls the vehicle 102.

The HMI 108 provides visual output, for example, a graphic user interface having graphical elements or indicators (for example, fixed or animated icons), lights, colors, text, images (for example, from the camera 108), combinations of the foregoing, and the like. The HMI 108 includes a suitable display device, for example the display 110, for displaying the visual output, for example, an instrument cluster, a mirror, a heads-up display, a center console display screen (for example, a liquid crystal display (LCD) touch screen, or an organic light-emitting diode (OLED) touch screen), or through other suitable devices. In some embodiments, the HMI 108 includes a graphical user interface (GUI) (for example, generated by the electronic controller 106, from instructions and data stored in the memory, and presented on a center console display screen) that enables a user to interact with the system 100. The HMI 108 may also provide audio output to the driver, for example, a chime, buzzer, voice output, or other suitable sound through a speaker included in the HMI 108 or separate from the HMI 108. In some embodiments, the HMI 108 includes components configured to provide haptic outputs to the driver, for example, to vibrate one or more vehicle components (for example, the vehicle's steering wheel and the driver's seat), for example, through the use of a vibration motor. In some embodiments, HMI 108 provides a combination of visual, audio, and haptic outputs. In some embodiments, the HMI 108 causes the visual, audio, and haptic outputs to be produced by a smart phone, a smart tablet, a smart watch, or other portable or wearable electronic device communicatively coupled to the vehicle 102.

The other vehicle systems 116 include controllers, sensors, actuators, and the like for controlling aspects of the operation of the vehicle 102 (for example, acceleration, braking, shifting gears, and the like). The other vehicle systems 116 are configured to send and receive data relating to the operation of the vehicle 102 to and from the electronic controller 106. For example, in some embodiments, the system 100 may include a steering controller 118 coupled to a steering system (not shown) of the vehicle 102. The steering controller 118 may be configured to automatically steer the vehicle 102 in response to commands received from, among other things, the electronic controller 106. The steering controller 118 may also receive steering commands from a steering wheel of the vehicle 102 (for example, in a “drive by wire” system). In some embodiments, the electronic processor 106 is configured to perform a parking and/or reverse assist function to guide (visually or automatically via the steering controller 118) the vehicle 102 (with or without the trailer 104) into a user-desired area surrounding the vehicle 102 to park.

FIG. 3 illustrates an exemplary method 300 for generating a rearview display of vehicle 102 coupled to the trailer 104. As an example, the method 300 is explained in terms of the electronic controller 106, in particular the electronic processor 202. However, it should be understood that portions of the method 300 may be distributed among multiple devices (for example, one or more additional controllers/processors of the system 100).

At block 302, determines a trailer angle of the vehicle 102 (for example, via an image analysis of one or more images from one or more of the cameras or a trailer angle sensor, which is not shown, within the trailer hitch 103), and, at block 304, the electronic processor 202 detects that the vehicle 102 is in a reverse gear or is turning (for example, turning onto a road or changing lanes on a road). The electronic processor 202 may determine that the vehicle is turning based on a steering angle of the steering wheel (determined for example, via a steering wheel angle sensor, not shown). In some embodiments, the electronic processor 202 determines that the vehicle 102 is turning, or going to turn, based on information from a route planning/navigation assistance system being used by a driver of the vehicle 102.

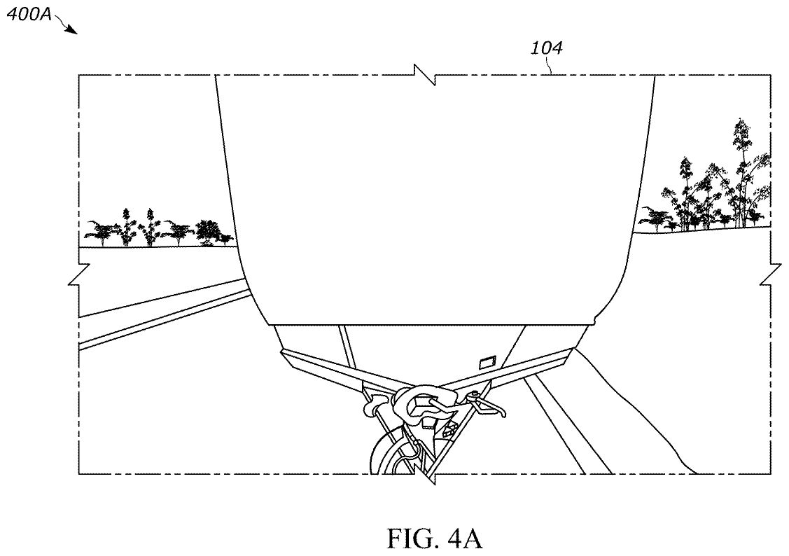

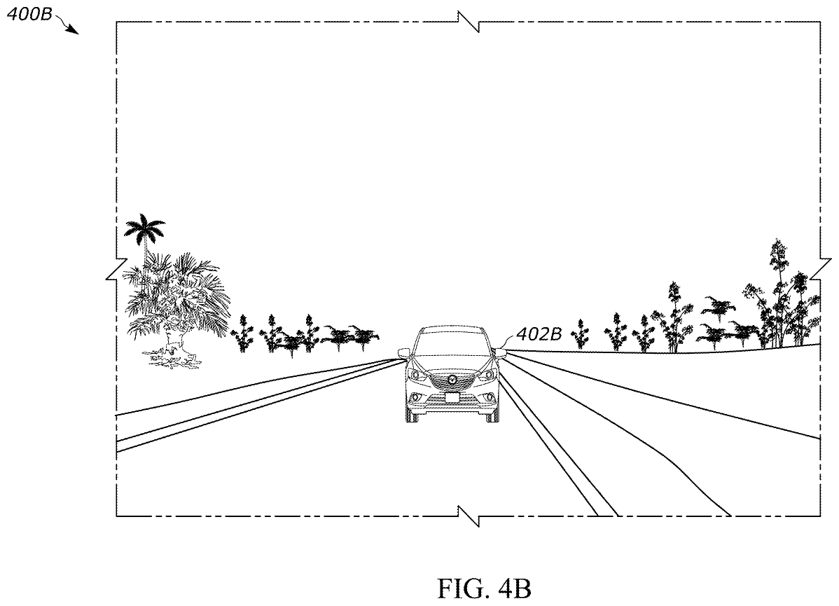

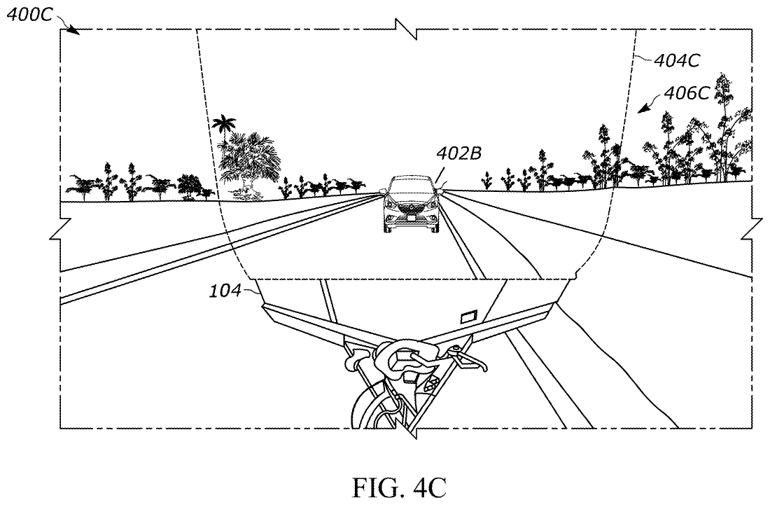

At block 308, the electronic processor 202 receives, from the rear-facing vehicle camera 112, a first video image including a first region of interest including the trailer 104 coupled to the vehicle 102. At block 310, the electronic processor 202 receives, from the rear-facing trailer camera 114 positioned on the trailer 104, a second video image including a second region of interest of a rearview of the trailer 104. FIG. 4A is an example first video image 400A from the vehicle camera 112. As illustrated in FIG. 4A, the first video image 400A is an image capture of a region behind the vehicle 102 and includes the trailer 104 coupled to the vehicle 102. FIG. 4B is an example second video image 400B from the trailer camera 114. As illustrated in FIG. 4B, the second video image 400B is an image capture of a region behind the trailer 104.

Returning to FIG. 3, at block 312, the electronic processor 202 generates a blended image based on the trailer angle, the first video image, and second video image and, at block 316, displays the blended image on a display (for example, the display 110). The blended image includes at least a portion of the second video image overlaid over the trailer 104 in the first video image. The blended image may be generated according to a blending/image stitching algothim, combining image data from both the first video image and the second video image. Following block 312, the method 300 returns to block 302.

FIG. 4C is an example of a blended image 400C generated based on the first video image 400A of FIG. 4A and the second video image 400B of FIG. 4B from the trailer camera 114. As illustrated in FIG. 4C, a portion 404C of the second video image 400B of FIG. 4B overlays the portion of the first video image 400A where the trailer 104 was. The portion 404C from the second video image 400B in the blended image 400C is modified, based on the trailer angle determined at block 304 of FIG. 3, such that the portion 404C visually appears to have been captured from approximately the same point of view as the first video image was captured (for example, scaled, zoomed, cropped, panned, skewed, and the like). The electronic processor 202 may also modify the portion 404C from the second video image 400B and/or the remaining portion 406C of the blended image 400C from the first video image 400A based on a position of the trailer camera 114 (the camera's x, y, z axis position, pitch, roll, yaw) in relation to the vehicle camera 112 and/or vice versa. The position of the cameras 112 and 114 may be determined, for example, via data from the camera itself, video image analytics, or from data input by a user. As shown in FIG. 4C, the visual result of the overlay of the portion 404C from the second video image 400B is such that the trailer 104 appears transparent, allowing a viewer of the image (for example, a driver of the vehicle 102) to see any objects behind the trailer 104.

The image modification of the portion 404C of the second video image may also be based on one or more dimensions (for example, width or height) of the trailer 104. The electronic processor 202 may determine the dimension information of the trailer 104, for example, directly from a user input (for example, via HMI 108) or automatically calculated via video analysis from images from one or more of the cameras (for example, vehicle camera 112). The electronic processor 202 may also modify either or both portions 404C and 406C based on a user input (for example, received via HMI 108).

In some embodiments, the blended image 400C includes one or more augmented indications or items. For example, in some embodiments, the electronic processor 202 is configured to augment an indication of one or more dimensions of the trailer into the generated blended image 400C. In some embodiments, the electronic processor 202 is configured to determine a predicted trajectory of the trailer 104 based on the trailer angle of the trailer 104 and augment the blended image 400C to include an indication of the predicted trajectory. In further embodiments, the electronic processor 202 is configured to identify one or more objects (for example, object 402B in FIGS. 4B and 4C) within the blended image 400C and augment the blended image 400C to highlight the object. The object may be a stationary or moving object (for example a pedestrian, a bicycle, a vehicle, and the like). In some embodiments, the electronic processor 202 is configured to detect an object (within or outside the region within the blended image 400C) that may intersect with a predicted trajectory of the trailer 104 and, in response, provide augment a visual indication of the object within the blended image 400C (for example, within the portion 404C). An object not within the blended image 400C may be detected by the electronic processor 202 if the object is within a field of view of the one or more cameras of the system 100. In further embodiments, the electronic processor 202 is configured to predict a trajectory of an object (for example, if the object is a moving object) within or outside of the region within the blended image 400C and determines if a collision with the trailer 104 and the moving object may occur (for example, based on a predicted trajectory of the trailer 104 and/or a distance of the object's predicted trajectory to the trailer 104). The electronic processor 202 may then augment a visual indication into the blended image 400C to alert the driver of the possible collision. The electronic processor 202 may additionally provide one or more indications (for example, an audible or haptic alert) to the user of the vehicle 102 to notify the user of a detected object and/or possible collision. In some embodiments, the electronic processor 202 may be configured to, following an initial indication of a possible collision, automatically control the vehicle 102 so as to avoid the possible collision (for example, automatically brake the vehicle 102).

Thus, embodiments provide, among other things, a trailer hitch camera system including a human machine interface.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Various features and advantages of the invention are set forth in the following claims.

What is claimed is:

1. A trailer-camera system for a vehicle, the system comprising:
a plurality of cameras, each configured to capture a video image, the plurality of cameras including
a rear-facing vehicle camera positioned on the vehicle to capture a first video image including a first region of interest including a trailer coupled to the vehicle;
a rear-facing trailer camera positioned on a trailer coupled to the vehicle to capture a second video image including a second region of interest of a rearview of the trailer; and
an electronic processor configured to:
detect that the vehicle is in a reverse gear or is turning;
determine a trailer angle of the vehicle;
generate a blended image based on the trailer angle, the first video image, and second video image, the blended image including an overlay of at least a portion of the second video image over the trailer in the first video image; and
display the blended image on the display.

2. The system of claim 1, wherein the electronic processor is further configured to identify an object within the blended image and augment the blended image to highlight the object.

3. The system of claim 1, wherein the electronic processor is further configured to determine a predicted trajectory of the trailer based on the trailer angle of the vehicle and augment the blended image to include an indication of the predicted trailer trajectory.

4. The system of claim 1 wherein the electronic processor is further configured to augment the blended image to include an indication of a dimension of the trailer.

5. A method for generating a rear-view display of a vehicle coupled to a trailer, the method comprising:
detecting that the vehicle is in a reverse gear or is turning;
determining a trailer angle of the vehicle;
generating a blended image based on the trailer angle, a first video image from a rear-facing vehicle camera positioned on the vehicle, the first video image including a first region of interest including a trailer coupled to the vehicle, and a second video image from a rear-facing trailer camera positioned on the trailer, the second video image including a second region of interest of a rearview of the trailer, the blended image including an overlay of at least a portion of the second video image over the trailer in the first video image; and
displaying the blended image on the display.

6. The method of claim 5, the method further comprising identifying an object within the blended image and augment the blended image to highlight the object.

7. The method of claim 5, the method further comprising determining a predicted trajectory of the trailer based on the trailer angle of the vehicle and augmenting the blended image to include an indication of the predicted trailer trajectory.

8. The method of claim 5, the method further comprising augmenting the blended image to include an indication of a dimension of the trailer.
